(19) United States
(12) Patent Application Publication
(10) Pub. No.: US 2019/0387421 A1
(43) Pub. Date: Dec. 19, 2019

(54) METHOD AND APPARATUS FOR MANAGING NETWORK ENVIRONMENT IN WIRELESS COMMUNICATION SYSTEM

(71) Applicant: Samsung Electronics Co., Ltd., Suwon-si, Gyeonggi-do (KR)

(72) Inventors: Minsung CHO, Seoul (KR); Sungbum PARK, Seoul (KR); Sungrok YOON, Seoul (KR)

(21) Appl. No.: 16/489,656

(22) PCT Filed: Feb. 2, 2018
(86) PCT No.: PCT/KR2018/001437

§ 371 Date: Aug. 28, 2019

(30) Foreign Application Priority Data
Feb. 28, 2017 (KR) 10-2017-0026164

(51) Int. Cl. H04W 24/04; H04B 17/309; H04W 16/28

(52) U.S. Cl. CPC H04W 24/04; H04W 16/28; H04B 17/309

(57) ABSTRACT

The present disclosure relates to a communication technique for converging an IoT technology with a 5G communication system for supporting a higher data transmission rate beyond a 4G system, and a system therefor. The present disclosure may be applied to an intelligent service (for example, a smart home, a smart building, a smart city, a smart car or connected car, healthcare, digital education, retail business, a security and safety related service, or the like) on the basis of a 5G communication technology and an IoT related technology. Various embodiments of the present invention relate to a method for managing a network environment of an electronic device in a wireless communication system. The method may comprise the steps of: acquiring beamforming information between a plurality of transmitting terminals and a plurality of receiving terminals; configuring a beamforming signal quality map for the plurality of transmitting terminals and the plurality of receiving terminals on the basis of the acquired beamforming information; detecting whether a connection problem between the transmitting terminals and the receiving terminals occurs, on the basis of the beamforming signal quality map; and when occurrence of the connection problem is detected, controlling a change in antenna setting information for at least one transmitting terminal. However, the present invention is not limited to the above embodiment, and other embodiments are possible.

### CROSS-REFERENCE TO RELATED APPLICATIONS

This application is a 371 National Stage of International Application No. PCT/KR2018/001437, filed Feb. 2, 2018, which claims priority to Korean Patent Application No. 10-2017-0026164, filed Feb. 28, 2017, the disclosures of which are herein incorporated by reference in their entirety.

### BACKGROUND

### 1. Field

The disclosure relates to a method and an apparatus for managing a network environment using beamforming information in a wireless communication system.

### 2. Description of Related Art

In order to meet wireless data traffic demands that have increased after 4G communication system commercialization, efforts to develop an improved 5G communication system or a pre-5G communication system have been made. For this reason, the 5G communication system or the pre-5G communication system is called a beyond 4G network communication system or a post LTE system. In order to achieve a high data transmission rate, implementation of the 5G communication system in an ultra-high frequency (mmWave) band (e.g., 28-60 GHz band) is being considered. In the 5G communication system, technologies such as beamforming, massive MEMO, full dimensional MIMO (FD-MIMO), array antenna, analog beamforming, and large scale antenna are being discussed as means to mitigate a propagation path loss in the mmWave band and increase a propagation transmission distance. Further, the 5G communication system has developed technologies such as an evolved small cell, an advanced small cell, a cloud radio access network (RAN), an ultra-dense network, device to device communication (D2D), a wireless backhaul, a moving network, cooperative communication, coordinated multi-points (CoMP), and received interference cancellation to improve the system network. In addition, the 5G system has developed advanced coding modulation (ACM) schemes such as hybrid FSK and QAM modulation (FQAM) and sliding window superposition coding (SWSC), and advanced access technologies such as filter bank multi carrier (FBMC), non orthogonal multiple access (NOMA), and sparse code multiple access (SCMA).

Meanwhile, the Internet has been evolved to an Internet Things (IoT) network in which distributed components such as objects exchange and process information from a human-oriented connection network in which humans generate and consume information. An Internet of Everything (IoE) technology in which a big data processing technology through a connection with a cloud server or the like is combined with the IoT technology has emerged. In order to implement IoT, technical factors such as a sensing technique, wired/wireless communication, network infrastructure, service-interface technology, and security technology are required, and research on technologies such as a sensor network, machine-to-machine (M2M) communication, machine-type communication (MTC), and the like for connection between objects has recently been conducted. In an IoT environment, through collection and analysis of data generated in connected objects, an intelligent Internet technology (IT) service to create a new value for peoples' lives may be provided. The IoT may be applied to fields such as those of a smart home, a smart building, a smart city, a smart car, a connected car, a smart grid, health care, a smart home appliance, or high-tech medical services through the convergence of the conventional information technology (IT) and various industries.

Accordingly, various attempts to apply the 5G communication to the IoT network are made. For example, technologies such as a sensor network, machine to machine (M2M), and machine type communication (MTC) are implemented by beamforming, MIMO, and array antenna schemes, which are 5G communication technologies. The application of a cloud RAN as the big data processing technology described above may be an example of convergence of the 5G technology and the IoT technology.

In the case of a mobile communication system up to now, if a change of the surrounding environment, that is, a change in terrain features, occurs during the configuration and operation of the corresponding network, the environment between a transmitter and a receiver is changed. Therefore, various efforts to overcome connection defects due to environmental changes are required. The SG system, which uses an ultra-high frequency band and thus has a relatively shortened wave propagation distance, requires more transmitters to be distributed in a predetermined area. Therefore, there is a need for a method that can more effectively solve a connection problem between a transmitter and a receiver due to environmental changes.

### SUMMARY

An aspect of the disclosure is to make a beamforming signal quality map by using the degree of change in a reception signal between a transmitter and a receiver, and minimize an input effort to improve network quality by using the beamforming signal quality map.

A method for managing a network environment of an electronic device in a wireless communication system according to an embodiment of the disclosure may include: obtaining beamforming information between a plurality of transmitters and a plurality of receivers; configuring, based on the obtained beamforming information, a beamforming signal quality map for the plurality of transmitters and the plurality of receivers; determining, based on the beamforming signal quality map, whether a connection problem between the transmitters and the receivers occurs; and if occurrence of the connection problem is detected, controlling a change in antenna configuration information relating to at least one transmitter.

An electronic device in a wireless communication system according to an embodiment of the disclosure may include: a transceiver configured to transmit and receive a signal; a controller configured to obtain beamforming information between a plurality of transmitters and a plurality of receivers, configure, based on the obtained beamforming information, a beamforming signal quality map for the plurality of transmitters and the plurality of receivers, determine, based on the beamforming signal quality map, whether a connection problem between the transmitters and the receivers occurs, and if occurrence of the connection problem is detected, control a change in antenna configuration information relating to at least one transmitter; and a storage unit configured to store the beamforming signal quality map.

According to a various embodiments of the disclosure, network environment change data between a transmitter and a receiver is periodically tracked and analyzed using artificial intelligence (AI), so that the cause of performance degradation can be modeled, and thus a best network state can be maintained.

### BRIEF DESCRIPTION OF THE DRAWINGS

FIG. 1 illustrates a schematic structure of a wireless communication system according to an embodiment of the disclosure;

FIG. 2 illustrates transmitter-receiver beamforming according to an embodiment of the disclosure;

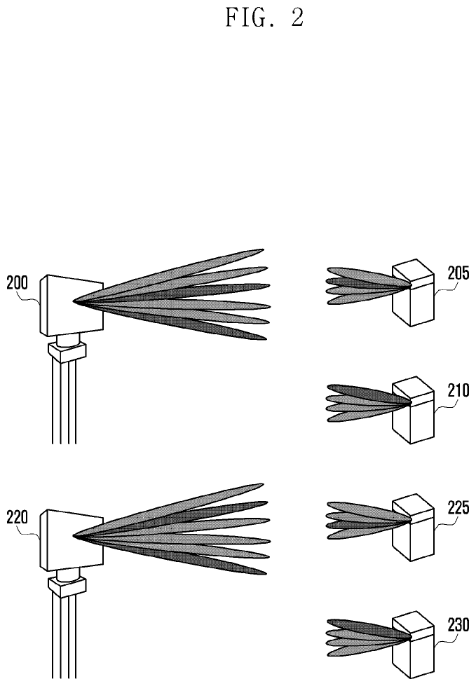

FIG. 3A illustrates a beamforming signal quality map according to an embodiment of the disclosure;

FIG. 3B illustrates a method for identifying occurrence of a transmitter-receiver connection problem in a beamforming signal quality map according to an embodiment of the disclosure;

FIG. 4 is a flowchart of a process of solving of a transmitter-receiver connection problem using beamforming according to an embodiment of the disclosure;

FIG. 5 is a flowchart for describing an example of a method for managing a network environment using a beamforming signal quality map according to an embodiment of the disclosure;

FIG. 6 is a flowchart for describing an example of a method for updating a beamforming signal quality map according to an embodiment of the disclosure;

FIG. 7 is a flowchart for describing an example of a method for solving occurrence of a transmitter-receiver connection problem according to an embodiment of the disclosure;

FIG. 8 is a block diagram schematically illustrating a configuration of a transmitter according to an embodiment of the disclosure; and

FIG. 9 is a block diagram schematically illustrating a configuration of a server configured to manage a network environment according to an embodiment of the disclosure.

### DETAILED DESCRIPTION

Hereinafter, the disclosure will be described with reference to the accompanying drawings. The disclosure includes various modification applicable thereto and has various embodiments, and specific embodiments are illustrated in drawings and detailed descriptions relating to specific embodiments are described herein. However, it should be understood that the disclosure is not limited to the specific embodiments, but the disclosure includes all modifications, equivalents, and alternatives within the spirit and the scope of the disclosure. In describing the drawings, similar reference numerals are used to designate similar elements.

In the disclosure, the expression “include” or “may include” refers to existence of a corresponding function., operation, or element, and does not limit one or more additional functions, operations, or elements. The terms such as “include” and/or “have” may be construed to denote a certain characteristic, number, step, operation, constituent element, component or a combination thereof, but may not be construed to exclude the existence of or a possibility of the addition of one or more other characteristics, numbers, steps, operations, constituent elements, components or combinations thereof.

In the disclosure, the expression “or” includes any or all combinations of words enumerated together. For example, the expression “A or B” may include A, may include B, or may include both A and B.

In the disclosure, expressions including ordinal numbers, such as “first” and “second,” etc., may modify various elements. However, such elements are not limited by above expressions. For example, the above expressions do not limit the sequence and/or importance of the corresponding constituent elements. The above expressions may be used merely for the purpose of distinguishing one element from the other elements. For example, a first user device and a second user device indicate different user devices although both of them are user devices. For example, a first element could be termed a second element, and similarly, a second element could be also termed a first element without departing from the scope of the disclosure.

In the case where an element is referred to as being “connected” or “accessed” to other elements, it should be understood that not only the element is directly connected or accessed to the other elements, but also another element may exist therebetween. Contrarily, when an element is referred to as being “directly coupled” or “directly connected” to any other element, it should be understood that no element is interposed therebetween.

In the disclosure, the terms are used to describe specific embodiments, and are not intended to limit the disclosure. As used e singular forms are intended to include the plural forms as well, unless the context clearly indicates otherwise.

Unless defined differently, all terms used herein, which include technical terminologies or scientific terminologies, have the same meaning as that understood by a person skilled in the art to which the disclosure belongs. Such terms as those defined in a generally used dictionary are to be interpreted to have the meanings equal to the contextual meanings in the relevant field of art, and are not to be interpreted to have ideal or excessively formal meanings unless clearly defined in the disclosure.

According to a technology employed in order to improve network quality between a transmitter and a receiver in a wireless communication system, a data collecting device carried by a movable body, such as a vehicle, moves in a targeted area in an actually operated network while collecting a radio signal in the area, a separate analyzing device analyzes the collected radio signal, and a result of the analysis is then applied to the network. According to the above-described technology, it is necessary to carry out periodic work by inputting cost and labor throughout the entire area as well as a corresponding area where a connection problem occurs. Further, there is a problem in that the collected data is mainly limited to a road on which a vehicle or people can move, and the data has a propagation characteristic limited to the time of measurement. In addition, since an actual location of a receiver is not considered and only a signal in a specific environment mainly based on a road is analyzed from the viewpoint of a transmitter, it is difficult to secure a representative value for optimal operation with respect to the corresponding environment. Particularly, a 5G system which uses an ultra-high frequency band, is characterized in that a transmitted signal has a relatively shortened wave propagation distance, and is not widely spread but rather is concentrated. Therefore, the above technology may result in a failure in collecting propagation characteristics at an actual reception location, thereby causing a difference in the degree of reception actually detected by a receiver.

A beam switching technology using a beam reference signal (BRS) and a beam refinement reference signal (BRRS) is used in order to improve network quality between a transmitter (e.g., a base station) and a receiver (e.g., a terminal), but the technology is only a technology for performing switching within given beams, so that there is still a difficulty in solving the problem for the entire area where a connection problem occurs.

In addition, an application of a self-organizing networks (SON) scheme has been attempted. However, the SON scheme has reached just a basic level of having achieved stabilization through load balancing by changing an output of a transmitter.

According to various embodiments of the disclosure, for example, a quality change in a periodic signal between a transmitter and a receiver may be monitored and used to produce a signal quality map.

According to various embodiments of the disclosure, with respect to an area having a quality lower than or equal to a reference value in the signal quality map, an antenna configuration value of a transmitter and/or a neighboring transmitter may be automatically changed into a value which can solve a connection problem for the corresponding area.

According to various embodiments of the disclosure, artificial intelligence (AI) through machine learning may be applied to define a connection problem and learn connection problem types so as to derive a solution,

In addition, if it is still difficult to solve the problem, it is possible to output a notification to an operator to enable the operator to visit the actual problematic area and solve the problem.

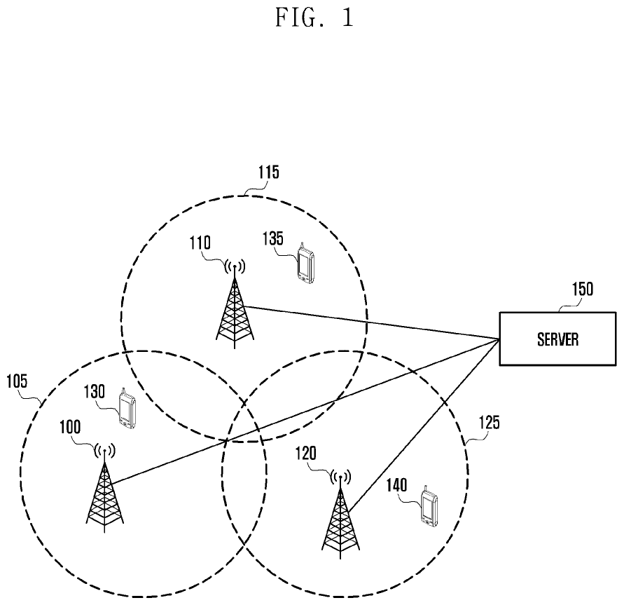

FIG. 1 illustrates a schematic structure of a wireless communication system according to an embodiment of the disclosure,

A wireless communication system includes base stations 100, 110, and 120 for operating a network. The base stations 100, 110, and 120 have coverages 105, 115, and 125 allowing them to provide services, respectively. The base stations 100, 110, and 120 may provide wireless communication services to terminals 130, 135 and 140 within the coverages 105, 115 and 125, respectively.

According to an embodiment of the disclosure, the wireless communication system may further include a server 150 configured to manage an environment of a wireless network and maintain optimal quality of the network. The server 150 may be a separate electronic device which is separate from the base stations 100, 110, and 120 or may be an element included in at least one of the base stations 100, 110, and 120.

The server 150 may obtain beamforming information from the base stations 100 110, and 120 and configure, based on the obtained beamforming information, a signal quality map within a network area. For example, the base stations 100, 110, and 120 may obtain channel measurement results from the terminal 130, 135, and 140 using a periodic signal, and transmit, to the server 150, beamforming information including the obtained channel measurement results.

The periodic signal may include, for example, a BRS, and the channel measurement results may include, for example, terminal-optimized beam information and signal quality information. Referring to FIG, 2, a first base station 200 may obtain beam pair information and signal quality information by periodically transmitting a BRS to first and second terminals 205 and 210 within a coverage. The beam pair information may be information obtained by combining terminal-optimized beam information and base station-optimized beam information. For example, the first base station 200 and the first terminal 205 may have a beam pair configured by beam 3 and beam 2, and the first base station 200 and the second terminal 210 may have a beam pair configured by beam 6 and beam 1. A second base station 220 may obtain beam pair information and signal quality information by periodically transmitting a BRS to third and fourth terminals 225 and 230 within a coverage. The second base station 220 and the third terminal 225 may have a beam pair configured by beam 2 and beam 3, and the second base station 220 and the fourth terminal 230 may have a beam pair configured by beam 6 and beam 1.

The beamforming information obtained by the server 150 from each base station may include at least one of beam pair information and signal quality information of a base station and a terminal. The signal quality information may include information obtained through channel measurement using the beam pair between a base station and a terminal.

The server 150 may detect a change in a signal quality map for a network area to identify occurrence of a connection problem between a base station and a terminal. The server 150 may identify, based on location information of a terminal obtained from a base station, an area where a problem occurs in the network area. For example, in the case where the terminal is a fixed receiver such as fixed wireless access (FWA), a base station may secure receiver location information at the time of installation. In the case where the terminal is a mobile receiver such as MBB, if a change to a signal quality to below a predefined criterion is detected, a base station around the corresponding receiver may record an issue occurrence location by using GPS information or location measurement.

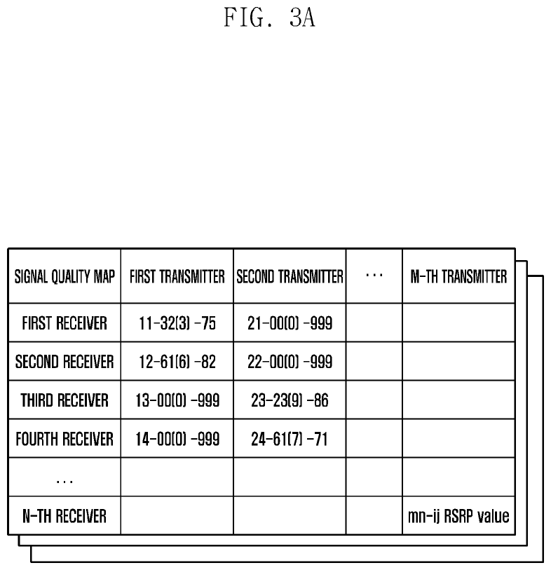

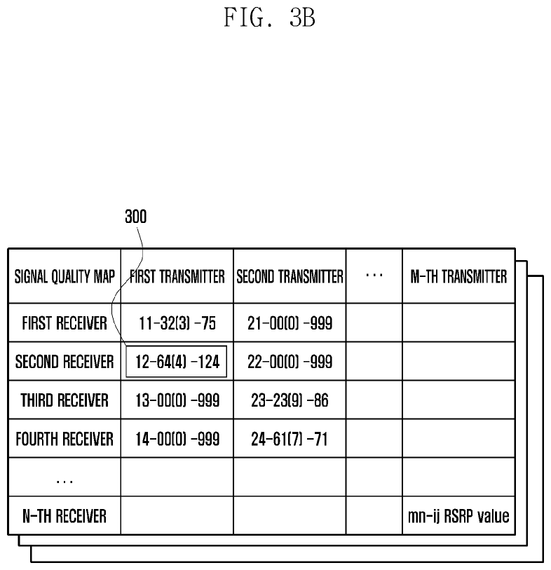

Referring to FIG. 3A, a signal quality map may include signal quality information between first to m-th transmitters (e.g., a base station) and first to n-th receivers (e.g., a terminal) in a network area. For example, the signal quality map may include a transmitter and receiver index (mn), a beam pair index (ij), a counted number (n) of times of signal measurement using the beam pair index, and signal quality information (e.g., reference signals received power (RSRP) value).

The signal quality map may be updated based on, for example, periodically obtained beamforming information. For example, signal quality information may be updated by reflecting the obtained beamforming information in real time or by statistically processing the beamforming information for a predetermined period. Further, the obtained beamforming information may be accumulatively reflected in real time or statistically processed for a predetermined period to change a beam pair index (beam index of a transmitter and/or a receiver) and update the signal quality information. Referring to FIG. 3B, it is noted that the beam pair index and the signal quality information between the first transmitter and the second receiver have been changed from those in the signal quality map shown in FIG. 3A 300. If signal quality less than or equal to a reference strength occurs at a specific beam pair index between a transmitter and a receiver, location information of the receiver may be obtained to determine a corresponding area as an area where a connection problem has occurred, and a review for solving the problem may be performed.

For example, the server 150 may control such that antenna configuration information of a base station in which a connection problem has occurred and/or a neighboring base station is changed, so as to solve the connection problem. The neighboring base station may be selected based on the identified problem occurrence area. If the connection problem is not solved, the server 150 may output a notification of the connection problem.

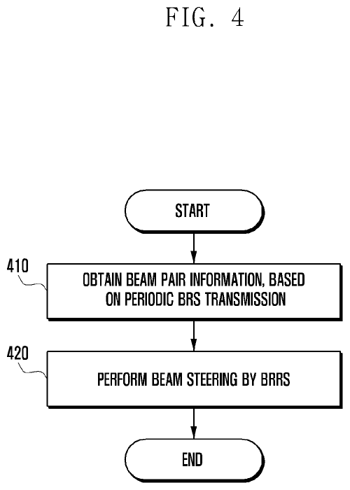

FIG. 4 is a flowchart of a process of solving of a transmitter-receiver connection problem using beamforming according to an embodiment of the disclosure.

For example, in operation 410, a base station may periodically transmit a BRS to a terminal to perform a periodic beam training process, and accordingly obtain beam pair information. The beam training process is a process of performing sweeping in a direction toward an available beam by using a reference signal for beam training, and then selecting an optimal beam, which is best to be used for transmission and reception of data and a control signal, with reference to signal qualities, such as reference signal received power (RSRP), received signal strength indicator (RSSI), reference signal received quality (RSRQ), or error vector magnitude (EVM) obtained from the sweeping. The BRS is a signal for measuring reception quality (e.g., RSRP) of a terminal for a specific beam. In a cellular network environment, a structure in which multiple terminals perform beamforming together on one base station is suitable.

The base station may sweep all available transmission beams in every BRS subframe, and the terminal may be fixed to one reception beam to measure terminal reception power according to the base station transmission beam. The operation may be repeated for all reception beams. As a result of a measurement of terminal reception power according to the reception beams, the terminal may feedback an optimal reception beam and corresponding signal quality to the base station. Through the process, the base station may obtain optimal beam pair information between the base station and the terminal.

In operation 420, the base station may transmit a BRRS to the terminal to perform an aperiodic beam training process, and accordingly perform beam steering. The aperiodic beam training process is a beam training process that requires separate triggering and is performed according to a link situation. If the base station transmits a beam refinement reference signal (BRAM) by scheduling, the terminal may obtain optimal beam information by performing measurement for the BRRS, and feedback an optimal reception beam and corresponding signal quality to the base station. Through the process, the base station may adjust a beam pair between the base station and the terminal.

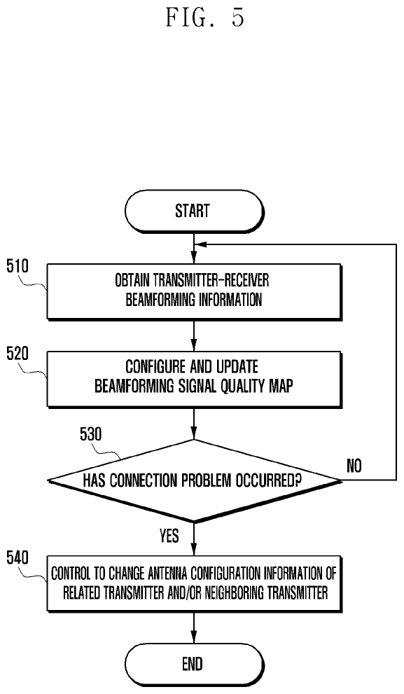

FIG. 5 is a flowchart for describing an example of a method for managing a network environment using a beamforming signal quality map according to an embodiment of the disclosure. A method for managing a network environment according to the present embodiment may be performed by, for example, the server 150 shown in FIG. 1.

Although not shown, the server may firstly determine whether there is an abnormality in a power source of transmitters (e.g., a base station) in a wireless communication network, and output a notification so that if there is a transmitting station having a problem, an operator can identify the problem.

In operation 510, the server may obtain beamforming information of a transmitter and a receiver (e.g., a terminal) from a plurality of transmitters. The beamforming information of a transmitter and a receiver may include beam pair information between the transmitter and the receiver, discussed above in FIG. 4, and signal quality information of a corresponding beam pair. The server may periodically obtain beamforming information.

In operation 520, the server may configure and update, based on the obtained beamforming information, a signal quality map in the network area. For example, the signal quality information may be updated by reflecting the obtained beamforming information in real time or by statistically processing the beamforming information for a predetermined period.

In operation 530, the server may detect occurrence of a connection problem in the network area, based on a change in the signal quality map. For example, in the case where it is detected that signal quality of a beam pair between a transmitter and a receiver is changed to be less than or equal to a reference strength in the updated signal quality map, the server may determine that a connection problem has occurred. In this case, the server may obtain location information of the receiver to determine a predetermined area based on the obtained location information as an area where the connection problem has occurred.

In operation 540, the server may control such that antenna configuration information of a transmitter related to the area, for example, a transmitter which the connection problem has occurred and/or a neighboring transmitter is changed. Antenna configuration information of a transmitter may be changed in order to solve the connection problem of a corresponding area. However, if such a change is not enough to solve the problem, antenna configuration information of a neighboring transmitter located adjacent to the corresponding area may be changed to solve the connection problem of the corresponding area. The antenna configuration information may include, for example, at least one of an azimuth angle, a tilt angle, and a beamforming scan range of an antenna. The adjustment of the beamforming scan range is distinguished from beam switching, and is to adjust an angle of the beamforming scan range, for example, a main bore-sight direction by changing a beamforming-related codebook. Based on the connection problem detected through signal quality analysis, the server may adjust at least one value of the azimuth angle, the tilt angle, and the beamforming scan range of the antenna so that the area where the problem has occurred can have an optimal connection state. For example, the server may give priority to adjusting the azimuth angle and the tilt angle of the antenna, and then adjust the beamforming scan range.

Various methods may be considered as follows in order to change an antenna configuration value to solve a connection problem. For example, the various methods may include a method for combining and analyzing existing data related to a corresponding problem area in a signal quality map in which data is accumulated and managed. In addition, a propagation path between neighboring transmitters may be predicted to consider a propagation environment analysis result when the neighboring transmitters point to the corresponding problem area.

If the connection problem is still not solved, the server may output a notification of the connection problem so that an operator of the corresponding network can identify the problem.

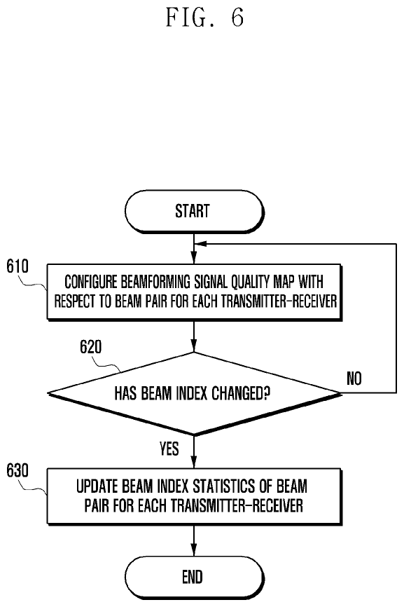

FIG. 6 is a flowchart for describing an example of a method for updating, by a server (e.g., 150 in FIG. 1), a beamforming signal quality map (e.g., a process in operation 520 in FIG. 5) according to an embodiment of the disclosure.

In operation 610, the server may configure and update, based on obtained beamforming information, a signal quality map in a network area. For example, the signal quality map may be updated by reflecting the obtained beamforming information in real time or by statistically processing the beamforming information for a predetermined period. The server may periodically obtain the beamforming information.

In operation 620, the server may determine, in the obtained beamforming information, whether a beam index of beam pair information between a transmitter and a receiver has changed. A change in the beam index implies that a beam pair for a wireless connection between a transmitting station and a receiving station has been changed or adjusted.

In operation 630, in the case where the changed beam index is received, the server may update the signal quality map by statistically processing the beam indices received for a predetermined period. In the case where beam pair information between a specific transmitter and a specific receiver is changed due to the update, signal quality information may also be updated based on the changed beam pair information.

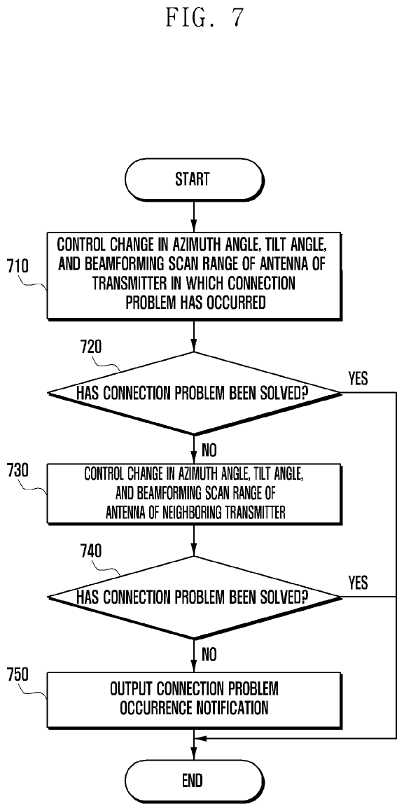

FIG. 7 is a flowchart for describing an example of a method for solving, by a server (e.g., 150 in FIG. 1), occurrence of a transmitter-receiver connection problem (e.g., a process in operation 540 in FIG. 5) according to an embodiment of the disclosure.

In operation 710, based on the connection problem detected through signal quality analysis, the server may control a change in antenna configuration values of a transmitter in which a connection problem has occurred, for example, an azimuth angle, a tilt angle, and a beamforming scan range value of the antenna. In this case, the server may prioritize a change in the azimuth angle and the tilt angle and control the change in the azimuth angle and the tilt angle, and if the signal quality is not sufficiently recovered, the server may control a change in the beamforming scan range value.

In operation 720, the server may determine whether the connection problem of the corresponding area has been solved, based on the change in the antenna configuration values of the transmitter in which the connection problem has occurred.

If the connection problem is not solved, in operation 730, the server may control a change in antenna configuration values of at least one neighboring transmitter related to the area where the connection problem has occurred, for example, an azimuth angle, a tilt angle, and a beamforming scan range value of the antenna. In this case, the server may prioritize a change in the azimuth angle and the tilt angle and control the change in the azimuth angle and the tilt angle, and if the signal quality is not sufficiently recovered, the server may control a change in the beamforming scan range value.

In operation 740, the server may determine, based on the change in the antenna configuration values of the neighboring transmitter, whether the connection problem of the corresponding area has been solved.

If the connection problem is not solved, in operation 750, the server may output a notification of the connection problem through, for example, an operation center, so that an operator of the corresponding network can identify the problem. The notification may include at least one of a visual, an audio, and a tactile notification.

In addition to such an example, according to various embodiments of the disclosure, the server may select a transmitter that can most efficiently solve a connection problem in an area where the problem has occurred, among transmitters in a network, based on stored data of a signal quality map, and control a change in antenna configuration values of the selected transmitter.

Therefore, according to an embodiment of the disclosure, the server can solve a connection failure problem which occurs in a network area by managing a signal quality map related to transmitters in the network area.

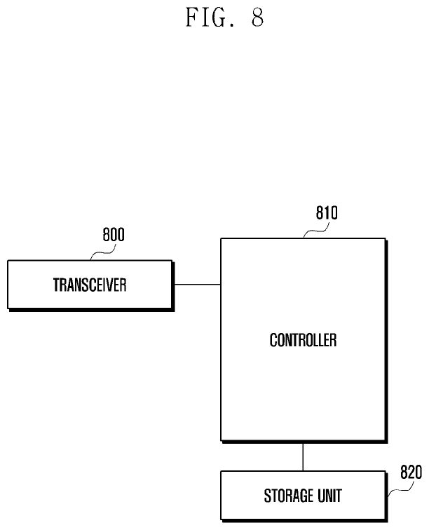

FIG. 8 is a block diagram schematically illustrating a configuration of a transmitter (e.g., a base station) according to an embodiment of the disclosure.

A transmitter according to an embodiment of the disclosure may include a transceiver 800, a controller 810, and a storage 820.

The transceiver 800 may be electrically connected to the controller 810 to transmit and receive a signal to and from external devices (e.g., a terminal and a server) under the control of the controller 810. The transceiver 800 may include an antenna capable of performing beamforming.

The controller 810 may control the operation of the transmitter according to various embodiments of the disclosure described above.

The controller 810 may transmit a BRS or a BRRS to a receiver (e.g., a terminal) through beam sweeping. The controller 810 may receive optimal reception beam information from the receiver, and identify an optimal beam pair, based on the information. The controller 810 may receive, from the receiver, signal quality information measured based on the corresponding beam pair.

The controller 810 may transmit, to the server, beamforming information including the signal quality information and optimal beam pair information. The controller 810 may periodically transmit the beamforming information to the server. The controller 810 may obtain location information of the receiver. If the controller 810 receives, from the server, a signal indicating that a connection problem has occurred, the controller 810 may transmit, to the server, the location information of the receiver in which the problem has occurred.

If the controller 810 receives an antenna configuration change signal from the server, the controller 810 may change an antenna configuration value, based on the received signal. For example, the antenna configuration value may include an azimuth angle, a tilt angle, and a beamforming scan range value of the antenna.

The storage unit 820 may store information obtained by the transmitter, for example, optimal beam pair information, signal quality information, or location information of the receiver.

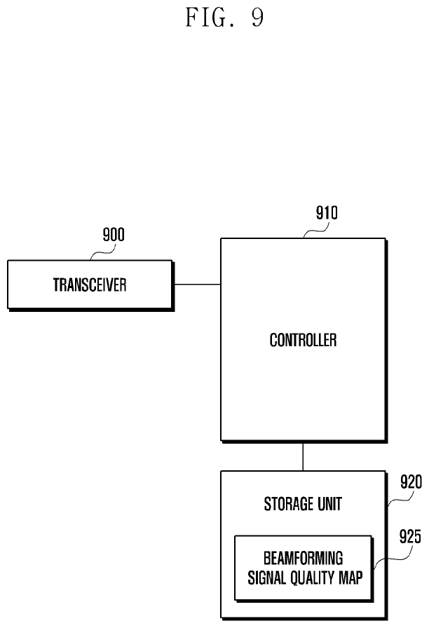

FIG. 9 is a block diagram schematically illustrating a configuration of a server configured to manage a network environment according to an embodiment of the disclosure.

A transmitter according to an embodiment of the disclosure may include a transceiver 900, a controller 910, and a storage 920.

The transceiver 900 may be electrically connected to the controller 910 to transmit and receive a signal to and from an external device (e.g., a transmitter) under the control of the controller 910.

The controller 910 may control the operation of the server according to various embodiments of the disclosure described above.

The controller 910 may obtain beamforming information between a plurality of transmitters and a plurality of receivers, and configure, based on the obtained beamforming information, a beamforming signal quality map for the plurality of transmitters and the plurality of receivers. For example, the beamforming information may include at least one of beam pair information and measured signal quality information, and may be obtained periodically. The beamforming signal quality map for a network area may include beam pair information relating to a connection between a transmitter and a receiver, signal measurement count information using a corresponding beam pair, and signal quality information measured using the corresponding beam pair.

The controller 910 may update the beamforming signal quality map by performing statistical processing in real time or for a predetermined period, based on newly obtained beamforming information. For example, if the controller 910 detects that beam pair information relating to a connection between a transmitter and a receiver, included in newly obtained beamforming information, is different from beam pair information relating to the connection between the transmitter and the receiver in the beamforming signal quality map, the controller 910 may update data by statistically processing a value of the beam pair information obtained during a predetermined period.

The controller 910 may determine whether a connection problem between a transmitter and a receiver occurs, based on the beamforming signal quality map. For example, the controller 910 may monitor a change in the measured signal quality information relating to a connection between a transmitter and a receiver, and determine whether the changed measured signal quality information becomes lower than a reference value, so as to determine whether the connection problem occurs.

If the controller 910 detects the occurrence of the connection problem, the controller 910 may control a change in antenna configuration information relating to at east one transmitter. For example, the antenna configuration information may include at least one piece of configuration information among an azimuth angle, a tilt angle, and a beamforming scan range of an antenna.

If the connection problem occurs, the controller 910 may obtain location information of the receiver in which the connection problem has occurred, and identify the at least one transmitter among the transmitters located in the network, based on the obtained location information of the receiver. For example, the at least one transmitter may include at least one of the transmitter in which the connection problem has occurred and the neighboring transmitters.

If the connection problem occurs, the controller 910 may control to output a notification of the connection problem between the transmitter and the receiver. For example, in the case where the changing of the antenna configuration information does not solve the connection problem, the controller 910 may control to output the notification as the last method.

The controller 910 may detect that beam pair information relating to a connection between a transmitter and a receiver, included in newly obtained beamforming information, is different from beam pair information relating to the connection between the transmitter and the receiver in the beamforming signal quality map, and update the beamforming signal quality map by statistically processing a value of the beam pair information obtained during a predetermined period.

The storage unit 920 may store the beamforming signal quality map 925 under the control of the controller 910.

Each of the above described elements of the electronic device according to various embodiments of the disclosure may be formed of one or more components, and the name of a corresponding element may vary according to the type of an electronic device. The electronic device according to various embodiments of the disclosure may include at least one of the above described elements and may exclude some of the elements or further include other additional elements. Further, some of the elements of the electronic device according to various embodiments of the disclosure may be coupled to form a single entity while performing the same functions as those of the corresponding elements before the coupling.

The part “˜ part”, “device”, or “module” used in various embodiments of the disclosure may refer to, for example, a “unit” including one of hardware, software, and firmware, or a combination of two or more of the hardware, software, and firmware. The “˜ part”, “device”, or “module” may be interchangeable with a term, such as a unit, a logic, a logical block, a component, or a circuit, The “˜ part”, “device”, or “module” may be a minimum unit or part of an integrally configured component. The “˜ unit”, “device”, or “module” may be a minimum unit or a of performing one or more functions. The “˜ unit”, “device”, or “module” may be implemented mechanically or electronically. For example, the “module” according to various embodiments of the disclosure may include at least one of an application-specific integrated circuit (ASIC) chip, a field-programmable gate array (FPGA), and a programmable-logic device for performing certain operations, which are now known or will be developed in the future.

Meanwhile, the exemplary embodiments disclosed in the specification and drawings are merely presented to easily describe technical contents of the disclosure and help the understanding of the disclosure and are not intended to limit the scope of the disclosure. Therefore, all changes or modifications derived from the technical idea of the disclosure as well as the embodiments described herein should be interpreted to belong to the scope of the disclosure,

1. A method for managing a network environment of an electronic device in a wireless communication system, the method comprising:
obtaining beamforming information between a plurality of transmitters and a plurality of receivers;
configuring, based on the obtained beamforming information, a beamforming signal quality map for the plurality of transmitters and the plurality of receivers;
determining, based on the beamforming signal quality map, whether a connection problem between the transmitters and the receivers occurs; and
controlling a change in antenna configuration information relating to at least one transmitter in a case that occurrence of the connection problem is detected.

2. The method as claimed in claim 1, wherein the antenna configuration information comprises at least one of an azimuth angle, a tilt angle, and a beamforming scan range of an antenna.

3. The method as claimed in claim 1, further comprising:
obtaining location information of a receiver in which the connection problem has occurred in a case that the connection problem occurs; and
identifying, based on the obtained location information of the receiver, the at least one transmitter.

4. The method as claimed in claim 3, further comprising controlling to output a notification of the connection problem between the transmitter and the receiver.

5. The method as claimed in claim 1, wherein the beamforming information comprises at least one of beam pair information and measured signal quality information, and is periodically obtained.

6. The method as claimed in claim 1, wherein the beamforming signal quality map comprises at least one of beam pair information relating to a connection between a transmitter and a receiver, signal measurement count information using a corresponding beam pair, and signal quality information measured using the corresponding beam pair.

7. The method as claimed in claim 6, wherein determining of whether a connection problem between a transmitter and a receiver occurs comprises: monitoring a change in the measured signal quality information relating to a connection between a transmitter and a receiver; and identifying whether the changed measured signal quality information becomes lower than a reference value.

8. The method as claimed in claim 6, further comprising:
detecting that beam pair information relating to a connection between a transmitter and a receiver, included in newly obtained beamforming information, is different from beam pair information relating to the connection between the transmitter and the receiver in the beamforming signal quality map; and
updating the beamforming signal quality map, based on a value of the beam pair information obtained during a predetermined period.

9. An electronic device in a wireless communication system, the device comprising:
a transceiver configured to transmit and receive a signal;
a controller configured to obtain beamforming information between a plurality of transmitters and a plurality of receivers, configure, based on the obtained beamforming information, a beamforming signal quality map for the plurality of transmitters and the plurality of receivers, determine, based on the beamforming signal quality map, whether a connection problem between the transmitters and the receivers occurs, and control a change in antenna configuration information relating to at least one transmitter in a case that occurrence of the connection problem is detected; and
a storage unit configured to store the beamforming signal quality map.

10. The device as claimed in claim 9, wherein the antenna configuration information comprises at least one of an azimuth angle, a tilt angle, and a beamforming scan range of an antenna.

11. The device as claimed in claim 9, wherein the controller is configured to obtain location information of a receiver in which the connection problem has occurred in a case that the connection problem occurs, and identify, based on the obtained location information of the receiver, the at least one transmitter.

12. The device as claimed in claim 11, wherein the controller is configured to further control to output a notification of the connection problem between the transmitter and the receiver.

13. The device as claimed in claim 9, wherein the beamforming information comprises at least one of beam pair information and measured signal quality information, and is periodically obtained, and
wherein the beamforming signal quality map comprises at least one of beam pair information relating to a connection between a transmitter and a receiver, signal measurement count information using a corresponding beam pair, and signal quality information measured using the corresponding beam pair.

14. The device as claimed in claim 13, wherein the controller is configured to monitor a change in the measured signal quality information relating to a connection between a transmitter and a receiver, and identify whether the changed measured signal quality information becomes lower than a reference value.

15. The device as claimed in claim 13, wherein the controller is configured to detect that beam pair information relating to a connection between a transmitter and a receiver, included in newly obtained beamforming information, is different from beam pair information relating to the connection between the transmitter and the receiver in the beamforming signal quality map, and update the beamforming signal quality map by statistically processing a value of the beam pair information obtained during a predetermined period.
